(19) United States
(12) Patent Application Publication
(10) Pub. No.: US 2026/0063578 A1
(43) Pub. Date: Mar. 5, 2026

(54) CURVED MIRROR AND INVERSE PHOTOEMISSION SPECTROMETER COMPRISING SAME

(71) Applicant: University-Industry Cooperation Group of Kyung Hee University, Yongin-Si, Gyeonggi-Do (KR)

(72) Inventors: Yongsup Park, Seoul (KR); Jong-Am Hong, Seoul (KR)

(73) Assignee: University-Industry Cooperation Group of Kyung Hee University, Yongin-Si, Gyeonggi-Do (KR)

(21) Appl. No.: 19/108,224

(22) PCT Filed: Sep. 19, 2023
(86) PCT No.: PCT/KR2023/014121

§ 371 Date: Mar. 3, 2025

(30) Foreign Application Priority Data
Sep. 21, 2022 (KR) 10-2022-0119524
Oct. 21, 2022 (KR) 10-2022-0136522

(51) Int. Cl. G01N 23/2251

(52) U.S. Cl. CPC G01N 23/2251; G01N 2223/309

(57) ABSTRACT

A curved mirror of the present invention includes a through-hole through which electrons incident on the sample pass, and a collecting surface, curved to surround the sample, for collecting photons emitted from the sample due to the passed electrons. The through-hole is formed on the collecting surface. Thereby, by applying a curved mirror structure that surrounds the sample, the photon collection performance from the sample surface can be improved.

### TECHNICAL FIELD

The present invention relates to a curved mirror and an inverse photoelectron spectrometer including the same. More specifically, the invention relates to a curved mirror, configured in a structure that surrounds a sample, thereby enhancing the collection efficiency of photons emitted from the surface of the sample, and to an inverse photoelectron spectrometer including the same.

### BACKGROUND ART

In recent years, the semiconductor field has experienced substantial growth, which has been driven by advancements in the display industry utilizing organic light-emitting diodes (OLEDs). Furthermore, extensive research and development efforts are actively being conducted in relation to organic photovoltaics (OPVs) and organic thin-film transistors (OTFTs).

When analyzing the properties of polymers or organic materials used in such semiconductor fields, it is understood that charge transport occurs in organic materials through the lowest unoccupied molecular orbital (hereinafter referred to as “LUMO”) and the highest occupied molecular orbital (hereinafter referred to as “HOMO”). Organic electronic devices are composed of a plurality of layers of organic thin films, and in order to optimize their performance, it is essential to minimize the energy level differences (charge injection barriers) between adjacent layers, including the electrodes. Such minimization facilitates smooth movement of charges.

Accordingly, detailed information regarding the electronic density of states (DOS) of the organic material itself, including the LUMO and the HOMO, as well as the energy level alignment at the junction interface with other materials, is critical. Specifically, an understanding of the electronic structure of the organic material is required. To this end, a representative method for measuring the electronic structure of solid samples is photoelectron/inverse photoelectron spectroscopy.

Photoelectron spectroscopy (hereinafter referred to as “PES”) is a method for analyzing the electronic structure of a material by measuring the energy of photoelectrons emitted as a result of the photoelectric effect when light of a specific energy, such as ultraviolet or X-rays, is incident on the material. When the energy of the incident light is known, analyzing the energy and intensity of the emitted photoelectrons enables tracking of the energy levels at which electrons are distributed within the material. Through this analysis, information regarding the HOMO level and the occupied energy levels of organic materials can be obtained.

Inverse photoelectron spectroscopy (hereinafter referred to as “IPES”) is the reverse process of photoelectron spectroscopy. In this method, free electrons with specific energy are incident on a sample, and the energy and intensity of photons emitted as the electrons transition into the unoccupied levels of the material are measured. Through this process, information regarding the LUMO level and the unoccupied energy levels of organic materials can be obtained.

In PES, the photoelectrons measured exhibit high output intensity yields relative to the incident light source. However, in IPES, the yield of emitted photons relative to the incident electrons is significantly lower. Furthermore, in low-energy inverse photoemission spectroscopy (hereinafter referred to as “LEIPS”), which employs electrons with energies below 5 eV to minimize damage to organic material samples, there is a limitation in increasing the number of incident electrons to enhance signal intensity.

Accordingly, even with the use of high-performance photon detectors and high-resolution electron guns, the longer measurement times and lower signal intensities, compared to PES and other material characterization techniques, have been obstacles to the commercialization of IPES technology.

Furthermore, in conventional IPES technology, to increase the yield, it is common to place the detector as close as possible to the sample or to use a plurality of detectors simultaneously and add the measured values. However, because photons are emitted radially from the surface of the sample, most of the emitted photons were not collected and were discarded.

Ultimately, there is a need for research and development of a technology that accurately measures the density of states of an electron's possible orbitals by using a low-energy electron beam to prevent damage to organic materials, directing electrons onto the surface of a sample, and measuring the photons emitted as the incident electrons stabilize.

### PRIOR ART REFERENCES

### Patent Literature

(Patent Literature 0001) Republic of Korea Laid-Open Patent Application No. 10-2002-0072983

### DETAILED DESCRIPTION OF THE INVENTION

### Technical Problem

The present invention is directed to solving the aforementioned problems and provides a curved mirror capable of improving the photon collection efficiency by applying a curved mirror structure that surrounds the sample, as well as an inverse photoelectron spectrometer including the same.

### Solution to the Problem

To achieve the above-mentioned objectives, a curved mirror according to an embodiment of the present invention includes: a through-hole through which electrons incident on a sample pass; and a collecting surface, curved to surround the sample, for collecting photons emitted from the sample by the electrons that have passed. The through-hole is formed on the collecting surface.

Additionally, in the through-hole, a diameter at a surface where the electrons are incident may be equal to or greater than a diameter at the collecting surface.

Additionally, the through-hole may be formed in a shape selected from a group consisting of a circular shape, an elliptical shape, a triangular shape, a square shape, a rectangular shape, a polygonal shape, and a slit shape.

Additionally, the collecting surface may be formed in a shape selected from a group consisting of an elliptical shape, a hemispherical shape, a parabolic shape, and a freeform curved shape.

Additionally, the curved mirror may further include a fixing hole secured by a clamp and a fixing shaft.

Additionally, the fixing shaft may be coupled to a coupling member in the fixing hole.

In another general aspect of the present invention, an inverse photoelectron spectrometer includes a support for supporting a sample for inverse photoelectron; the curved mirror of claim 1 disposed on the sample; an electron beam passing through the curved mirror and incident on the sample; and a detector for detecting photons emitted from the sample and collected by the curved mirror.

Additionally, the detector may include: a filter for increasing density of the photons and filtering the photons; and a photomultiplier tube for amplifying the filtered photons.

### Effects of the Invention

The curved mirror and the inverse photoelectron spectrometer including the same according to the present invention, as described above, can improve the photon collection efficiency by applying a curved mirror structure that surrounds the sample.

Furthermore, it can prevent damage to the sample and enhance the accuracy of the measurement and analysis.

### BRIEF DESCRIPTION OF THE DRAWINGS

FIG. 1 is an exemplary diagram illustrating a curved mirror according to an embodiment of the present invention.

FIG. 2 is an exemplary diagram illustrating a curved mirror according to another embodiment of the present invention.

FIG. 3 is a perspective view illustrating an example in which a curved mirror according to an embodiment of the present invention is fixed.

FIG. 4 is a schematic conceptual diagram illustrating a photoelectron spectrometer including a curved mirror according to an embodiment of the present invention.

FIG. 5 is an exemplary diagram showing the detector of FIG. 4.

FIG. 6 is an exemplary diagram schematically illustrating an inverse photoelectron spectrometer including a curved mirror according to another embodiment of the present invention.

FIG. 7 is a graph showing a comparative example of measuring a sample using an inverse photoelectron spectrometer including a curved mirror according to an embodiment of the present invention.

### BEST MODE FOR CARRYING OUT THE INVENTION

Hereinafter, preferred embodiments of the present invention will be described in detail with reference to the accompanying drawings to clarify the technical spirit of the present invention. In describing the present invention, detailed descriptions of well-known functions or components will be omitted if it is determined that they would unnecessarily obscure the gist of the invention. For elements having substantially the same functional configuration, even if shown in different drawings, the same reference numerals and symbols have been assigned wherever possible. For convenience of explanation, devices and methods may be described together as necessary.

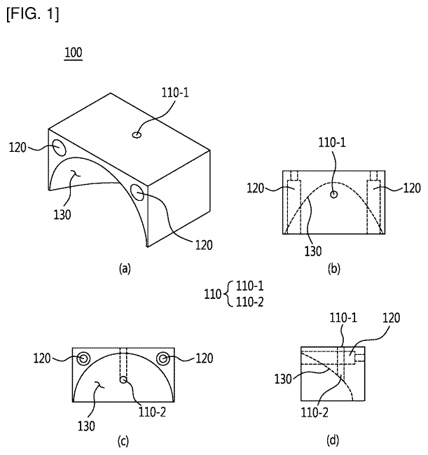

FIG. 1 is an exemplary diagram showing a curved mirror according to an embodiment of the present invention.

Referring to FIG. 1, (a) illustrates a perspective view of a curved mirror 100 of the present invention, (b) illustrates a top view of the curved mirror 100, (c) illustrates a front view of the curved mirror 100, and (d) illustrates a right-side view of the curved mirror 100.

The curved mirror 100 may include a through-hole 110 through which electrons that are incident on the sample pass and a collecting surface 130 which is curved to surround the sample and collects photons emitted from the sample by the transmitted electrons. In this case, the through-hole 110 may be formed on the collecting surface 130.

In the through-hole 110, a diameter 110-1 at a surface where electrons are incident may be equal to or greater than a diameter 110-2 at the collecting surface. In an embodiment, in the through-hole 110, a through-diameter 110-1 at the surface where electrons are incident and a through-diameter 110-2 at the surface where electrons are emitted may be equal.

Additionally, the diameter of the through-hole 110 may be formed in any one of the following shapes: circular, elliptical, triangular, square, rectangular, polygonal, or slit-shaped. Furthermore, the through-hole 110 may have a tubular shape through which electrons can pass, and its diameter may be formed in various shapes.

In an embodiment, the diameter 110-1 at a surface where electrons are incident, of the through-hole 110, may be formed in any one of the following shapes: circular, elliptical, triangular, square, rectangular, polygonal, or slit-shaped. Conversely, the diameter 110-2 at the collecting surface of the through-hole 110 may also be formed in any one of the following shapes: circular, elliptical, triangular, square, rectangular, polygonal, or slit-shaped.

Meanwhile, the diameter of the through-hole 110 may be designed and implemented in various ways. That is, the diameter of the through-hole 110 and the size of the curved mirror may be adjusted according to the size of the sample. Preferably, when the size of the sample is 2 cm*2 cm, the diameter of the through-hole 110 may be designed to be 2 mm.

In an embodiment, the through-hole 110 is implemented with both the diameter 110-1 at the electron incident surface and the diameter 110-2 at the collecting surface in a circular shape; however, the diameter 110-2 at the collecting surface may be implemented in a slit shape. This allows for the adjustment of an incident angle while maintaining the focus (incident point) of the electrons that enter the sample based on the diameter shape of the through-hole 110-2.

The collecting surface 130 may have a curved shape to increase the capability of collecting photons emitted from the sample. Furthermore, the collecting surface 130 may be formed by calculating an optimized focal length and may have any one of the following shapes: elliptical, hemispherical, parabolic, or freeform.

The curved mirror 100 may be implemented with a material that has excellent reflectivity in the ultraviolet (UV) and vacuum ultraviolet (vacuum UV) wavelength ranges. In an embodiment, the curved mirror 100 may be implemented with a bare aluminum metal mirror. Such a curved mirror 100 may be implemented by precision machining of a metal material. Specifically, the curved mirror 100 may be processed through a diamond turning machine and subjected to post-polishing.

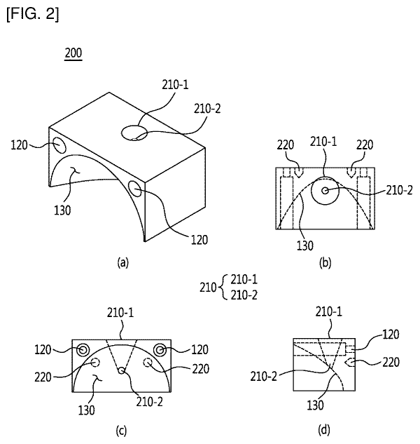

FIG. 2 is an exemplary diagram illustrating a curved mirror according to another embodiment of the present invention.

Referring to FIG. 2, (a) shows a perspective view of a curved mirror 200 of the present invention, (b) shows a top view of the curved mirror 200, (c) shows a front view of the curved mirror 200, and (d) shows a right-side view of the curved mirror 200.

The curved mirror 200 includes a through-hole 210 through which electrons incident on the sample pass, and a collecting surface 130 formed in a curved shape to surround the sample and collect photons emitted from the sample by the transmitted electrons. The through-hole 210 may be formed on the collecting surface 130.

In the through-hole 210, a through-diameter 210-1 at a surface where electrons are incident may be equal to or greater than a through-diameter 210-2 at the collecting surface. That is, the through-hole 210 may be shaped to gradually taper from the through-diameter 210-1 at the surface where the electrons are incident to the through-diameter 210-2 at the surface where they are emitted.

In the embodiment, in the through-hole 210, a through-diameter 210-1 at the surface where the electrons are incident may be larger than the through-diameter 210-2 at the surface where the electrons are emitted. At this time, the diameter 110-2 at the collecting surface 130 of the through-hole 210 may be 2 mm. Accordingly, electrons incident can be stably incident.

Additionally, the through-hole 210 may be formed in any one of the following shapes: circular, elliptical, triangular, square, rectangular, polygonal, or slit-shaped. Furthermore, the through-hole 210 may have a tubular shape through which electrons can pass, and its diameter may be formed in various shapes.

In the embodiment, the shape of the diameter 210-1 at the surface where electrons are incident of the through-hole 210 and the shape of the diameter 210-2 at the collecting surface of the through-hole 210 may be formed to be either the same or different from each other.

In the embodiment, the through-hole 210 is implemented with both the diameter 210-1 at the surface where electrons are incident and the diameter 210-2 at the collecting surface in a circular shape; however, the shape of the diameter 210-2 at the collecting surface may be implemented in a slit shape. Thus, the focal point of the electrons that are incident on the sample (the point where they are incident) can be maintained while allowing for a change in the incident angle, due to the shape of the diameter 210-2 of the through-hole.

The collecting surface 130 may be formed into a curved shape to increase the ability to collect photons emitted from the sample. Furthermore, the collecting surface 130 is formed by calculating an optimized focal length, and may be formed into one of the following shapes: elliptical, hemisphere, parabolic, or freeform.

The curved mirror 200 may be implemented using a material with excellent reflectivity in the ultraviolet (UV) and vacuum ultraviolet wavelength ranges. In an embodiment, the curved mirror 200 may be implemented with a bare aluminum metal mirror. Such a curved mirror 200 can be implemented by precision machining a metallic material. Specifically, the curved mirror 200 may be processed using a diamond turning machine and subsequently polished.

### MODE FOR CARRYING OUT THE INVENTION

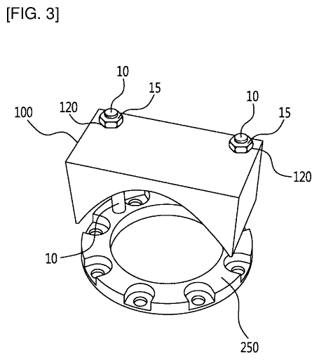

FIG. 3 is a perspective view illustrating an example in which a curved mirror according to an embodiment of the present invention is fixed.

Referring to FIGS. 1 to 3, a curved mirror 100 may be fixed to a clamp 250 by a fixing shaft 10. The fixing shaft 10 may be inserted into a fixing hole 120 and coupled to a coupling member 15. In this case, the coupling member 15 may be implemented as a nut, with one end of the fixing shaft 10 having threads formed thereon such that the nut 15 may be coupled to the fixing shaft 10. In this manner, the curved mirror 100 is securely fixed by being coupled to the clamp 250.

Such a clamp 250 may be coupled with either an electron beam or a detector of an inverse photoelectron spectrometer or a photoelectron spectrometer.

In the end, the curved mirror 100 may be coupled with the electron beam or the detector and may be arranged to surround the sample.

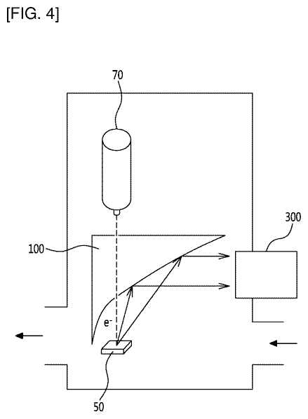

FIG. 4 is a schematic conceptual diagram illustrating an inverse photoelectron spectrometer including a curved mirror according to an embodiment of the present invention.

Referring to FIG. 1 and FIG. 4, the inverse photoelectron spectrometer may include: a support that holds a sample 50 within a vacuum chamber, a curved mirror 100 positioned on the sample 50 and shaped to surround the sample 50, an electron beam 70 that is incident on the sample 50 through the curved mirror 100, and a detector 300 that detects photons emitted from the sample 50 and collected by the curved mirror 100.

The sample 50 may be fixed and supported on the support. In this case, the sample is an organic material and is capable of emitting photons when irradiated with incident electrons. Here, the sample may be configured in a size suitable for measuring the density of states.

The electron beam 70 may irradiate with low-energy electrons of high resolution while having minimal impact on the organic material. This electron beam 70 may be implemented using an electron gun that allows for a simple lens configuration while achieving a high beam current. Specifically, the electron beam 70 is composed of a single cathode and three cylindrical lenses (for example, an extraction lens, a focusing lens, and a final lens), with spacers used between the lenses and the cathode to maintain the insulation of the lenses and ensure that each lens maintains its respective voltage. Here, the spacers may be made of a ceramic material as an insulator.

The internal structure of the electron beam 70 may include an anode positioned between the cathode and the extraction lens (extractor) to increase the emission of electrons from the cathode and the connection efficiency of the electron beam. The anode is connected to the extraction lens and has the same voltage. A hole is formed at the center of the anode, allowing electrons from the cathode to escape. Due to the high positive voltage applied to the anode, a large number of electrons are drawn out from the cathode and enter the lens through the hole. The focusing lens reduces the spread of the electron beam and allows for control of the beam's focus. Additionally, the focusing lens may serve as a filter by blocking electrons with a voltage lower than −0.9V₀, thus filtering based on the energy of the electrons. The final lens, which has a ground potential, may prevent charging between the sample and the electron gun. The connection wires supplying voltage to each lens are covered with insulating material, minimizing interference between the lenses.

The curved mirror 100 may collect photons emitted from the sample 50. In this case, the curved mirror 100 is arranged to surround the sample 50, thereby converting the photons emitted from the sample 50 into collimated light, which can then be directed to the detector 300.

The detector 300 is of the photomultiplier tube type and is capable of detecting photons incident as collimated light by the curved mirror 100.

In conclusion, the inverse photoelectron spectrometer of the present invention is capable of measuring and analyzing a sample using low-energy electrons.

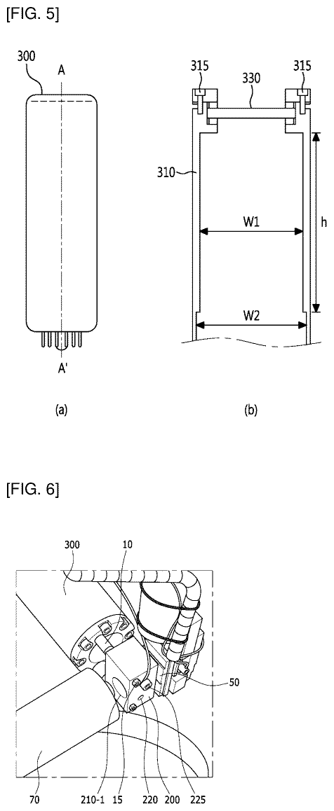

FIG. 5 is an exemplary diagram showing the detector of FIG. 4.

Referring to FIG. 4 and FIG. 5, (a) shows a simplified representation of the detector 300, and (b) shows a cross-sectional view of the detector 300 along line A-A′. The detector 300 of the present invention may include a filter 330 and a photomultiplier tube 310.

The filter 330 may increase the photon intensity in a vacuum and filter the photons. Thus, the filter 330 serves as a window while also performing the function of filtering photons of a specific wavelength. The filter 330 may be coupled to the photomultiplier tube 310 through a fixing member 315.

The photomultiplier tube (PMT) 310 may amplify the filtered photons. This photomultiplier tube 310 is suitable for use in a vacuum and is sensitive to the amplification of photons with low energy at specific wavelengths. That is, the photomultiplier tube 310 may convert irregularly fluctuating signals, depending on the incoming light particles through the filter 330, into a steady periodic analog signal of constant intensity through a photon counter. Meanwhile, an outer diameter (W1) of the photomultiplier tube 310 may be implemented to be smaller than an outer diameter (W2) of the socket.

FIG. 6 is an exemplary diagram schematically illustrating an inverse photoelectron spectrometer including a curved mirror according to another embodiment of the present invention.

Referring to FIG. 2 and FIG. 6, the curved mirror 200 may be implemented as a fixed structure through a fixed shaft 10, which is secured by a clamp 250 that is coupled to the detector 300.

The curved mirror 200 is arranged to surround the sample 50, but with the electron incident surface 210-1 of the through-hole 210 facing the electron beam 70, allowing electrons incident from the electron beam 70 to pass through, while the collecting surface 130 is positioned to face the sample 50.

Thus, when electrons from the electron beam 70 are incident on the sample 50, the photons emitted from the sample 50 are collected through the curved mirror 200, which has the focal point at a location where light is emitted. These photons are converted into collimated light and can be detected by the detector 300, allowing the photons to be measured and analyzed.

Thus, the present invention significantly improves the amount of photons collected through the curved mirror, enhancing the performance of the inverse photoelectron spectroscopy technique. Furthermore, the present invention can be used, in conjunction with ultraviolet spectroscopy, for the identification of electron and hole transport characteristics through energy bandgap measurements.

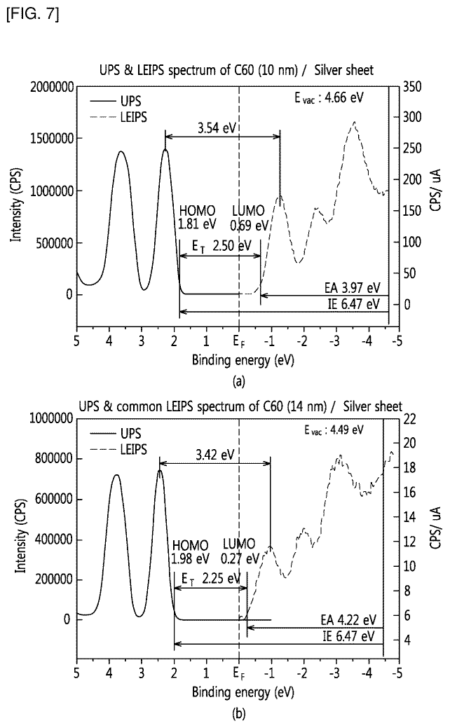

FIG. 7 is a graph showing a comparative example of measuring a sample using an inverse photoelectron spectrometer including a curved mirror according to an embodiment of the present invention.

Referring to FIG. 7, in a sample that is an organic material with vacant electron orbitals, the incident electrons stabilize, and depending on the initial kinetic energy of the electron, the spectrum and intensity of the photons emitted by the stabilized electrons vary. The intensity spectrum of the photons, which is distinguished according to the density of states of the corresponding electron orbitals, is obtained. Thus, by counting the number of photons for each electron kinetic energy, and by measuring the count for each kinetic energy along the x-axis, it is possible to analyze the electron orbitals within the sample.

The right dashed graph in (a) shows the results of measuring the change in count when electrons ranging from 0 eV to 5 eV are incident on a C60 layer approximately 10 nm thick deposited on Ag, using an inverse photoelectron spectrometer that includes the curved mirror. The right dashed graph in (b) shows the results of measuring the change in count when electrons ranging from 0 eV to 5 eV are incident on a 14 nm layer, using a inverse photoelectron spectrometer that does not include the curved mirror.

The left solid line graphs in (a) and (b) show the results of measuring the same sample under similar conditions using a photoelectron spectrometer.

The x-axis represents the electron's binding energy, and the y-axis represents the intensity of the photoelectron spectroscopy signal in counts per second (CPS), while the intensity of the inverse photoelectron spectroscopy signal is represented in counts per second/microampere (CPS/uA). Since the intensity of the inverse photoelectron spectroscopy signal in CPS may be adjusted by increasing the amount of incident electrons, the comparison is made based on the signal generated per unit time per injected electron. By using CPS/uA, the improvement in the photon collection capability of the inverse photoelectron spectroscopy, which is the core of the present invention, can be directly compared.

When comparing the two graphs, the results obtained using the inverse photoelectron spectrometer that includes the curved mirror showed a sensitivity (sensitivity) more than 15 times higher than the results obtained using the inverse photoelectron spectrometer that does not include the curved mirror. That is, when using the present invention, the CPS/uA value for the LUMO of the sample (C60) organic material is 300 CPS/uA, while the common LEIPS is 20 CPS/uA.

In conclusion, the present invention enables precise analysis of the electron orbitals within the sample in a much shorter time.

The present invention has been described in detail with reference to the preferred embodiments shown in the drawings. These embodiments are merely illustrative and should not be construed as limiting the invention. They are to be considered from a descriptive, rather than a restrictive, standpoint. The true scope of the present invention is defined not by the foregoing description, but by the technical spirit of the appended claims. Although specific terms have been used in this specification, they are intended solely for the purpose of explaining the concepts of the invention and are not meant to limit the scope of the invention as defined in the claims. The steps of the present invention do not necessarily have to be performed in the order described, and they may be carried out in parallel, selectively, or individually. A person skilled in the art to which the invention pertains will understand that various modifications and equivalent embodiments are possible within the essential technical concept of the invention as claimed in the patent claims, without departing from the scope of the invention. Equivalents include not only those currently known but also any future-developed equivalents, meaning all components designed to perform the same function, regardless of their structure.

### INDUSTRIAL APPLICABILITY

The curved mirror according to the present invention, by applying a structure that surrounds the sample, can improve the photon collection performance from the surface of the sample, and thus can be utilized in an inverse photoelectron spectrometer.

What is claimed is:

1. A curved mirror, comprising:
a through-hole through which electrons incident on a sample pass; and
a collecting surface, curved to surround the sample, for collecting photons emitted from the sample by the electrons that have passed through the through-hole;
wherein the through-hole is formed on the collecting surface.

2. The curved mirror of claim 1,
wherein, in the through-hole, a diameter at a surface where the electrons are incident is equal to or greater than a diameter at the collecting surface.

3. The curved mirror of claim 1,
wherein the through-hole is formed in a shape selected from a group consisting of a circular shape, an elliptical shape, a triangular shape, a square shape, a rectangular shape, a polygonal shape, and a slit shape.

4. The curved mirror of claim 1,
wherein the collecting surface is formed in a shape selected from a group consisting of an elliptical shape, a hemispherical shape, a parabolic shape, and a freeform curved shape.

5. The curved mirror of claim 1, further comprising:
a fixing hole secured by a clamp and a fixing shaft.

6. The curved mirror of claim 1,
wherein the fixing shaft is coupled to a coupling member in the fixing hole.

7. An inverse photoelectron spectrometer, comprising:
a support for supporting a sample;
the curved mirror of claim 1 disposed on the sample;
an electron beam passing through the curved mirror and incident on the sample; and
a detector for detecting photons emitted from the sample and collected by the curved mirror.

8. The inverse photoelectron spectrometer of claim 7,
wherein the detector comprises:
a filter for increasing density of the photons and filtering the photons; and
a photomultiplier tube for amplifying the filtered photons.
